(19) United States
(12) Patent Application Publication
(10) Pub. No.: US 2002/0124058 A1
(43) Pub. Date: Sep. 5, 2002

(54) Navigation device

(76) Inventor: Jakob Ehrensvard, Taby (SE)

Correspondence Address: RENNER, OTTO, BOISSELLE & SKLAR, LLP, Nineteenth Floor, 1621 Euclid Avenue, Cleveland, OH, 44115-2191, US

(21) Appl. No.: 09/972,806

(22) Filed: Oct. 5, 2001

Related U.S. Application Data
(60) Provisional application No. 60/239,359, filed on Oct. 11, 2000.

(51) Int. Cl. G06F 15/16

(52) U.S. Cl. 709/219; 709/203

(57) ABSTRACT

A device for use to automatically navigate to a pre-programmed address in a network. The navigation device includes an interface coupling circuit, a microprocessor, a memory device and an input device. The navigation device may be easily transported by the holder and is preferably in the shape of a card or token. The navigation device is programmed to store a unique identification number and at least one network address. In operation, the holder places the navigation device in contact with or in proximity to an interface, whereby the stored network address is automatically retrieved from the memory device and a web browser application is accessed and navigates to the particular address. If more than one address is stored in the memory device, then the navigation device selects the appropriate address based on a condition or event. In addition to automatically navigating the holder to a desired address in the network, the device can be used to automatically navigate to favorite addresses, each being assigned to a corresponding key or sequence of keys on the input device. Accordingly, the holder may access a favorite address in the network, without each time having to enter the appropriate text, by selecting the associated key or sequence of keys via the input device.

### RELATED APPLICATION DATA

This application claims priority of U.S. Provisional Application No. 60/239,359 filed Oct. 11, 2000, which is hereby incorporated herein by reference in its entirety.

### BACKGROUND OF THE INVENTION

1. Field of the Invention

The present invention relates to a navigation device for a software application environment.

2. Description of Related Art

Today's explosion in Internet usage presents several challenges. One noteworthy impediment, especially for inexperienced users, is the cumbersome task of having to input relative long Universal Resource Locators (URLs) to navigate between favorite locations. The probability of typing in the specified URL address incorrectly or simply finding the task to daunting can prevent visitors from accessing a particular site or service. One common solution to overcome this problem is to select from among a list of favorite URLs stored in a “favorites folder” and identified by respective readily recognizable user-friendly names. This solution raises another issue that the “favorites folder” is stored as a file on a particular computer and thus cannot be accessed by the user from a different terminal.

A related mobility issue is the problem of “cookies”, i.e., personal settings and information that the particular user has attended a given web site which are stored in a local memory of the computer. This approach addresses a single user on a single computer, or in some cases, a single user on a multi-user computer with different logon accounts. Again, the account itself is tied to the user, not the visitor.

Worldwide wideband connections and an interactive environment provides an ideal marketplace for immaterial products and/or services, such as music, books, software, on-line magazines, financial information, sports results, weather forecasts, entertainment services, media service, information services, application service provider services (where a user pays for usage rather than a flat license fee). In selling immaterial products or subscriptions to immaterial services, it is highly desirable to allow the user to immediately download on a trial basis a particular product or service as if the user were instantly purchasing or subscribing to the product or service. The margin cost for distributing immaterial products or providing access to immaterial services, including on-line user documentation available for download, is negligible. However, licensing and billing of products and services in today's Internet market economy requires rather complex software applications. No adequate working model is currently available to adequately address the licensing and billing issues. Any request by the provider for the user to supply a credit card number raises security issues that may discourage the user thereby quickly diminishes the simple “click and go” feeling.

Still another licensing issue is the problem of restricting a license to expire after a predetermined period of usage as measured, for example, in increments of time (years, months, days, hours, minutes or seconds) or number of times accessed. Conventional paper tickets entitle the holder to use a specified service or product for a predetermined period of time (e.g., a day) or a specified number of access times (e.g., one ride). Such conventional tickets are vulnerable to counterfeiting and their properties can not be changed. This has evolved into the use of electronic cards with magnetic strips that typically include less than 128 bits of non-volatile data.

Heretofore, no convenient or practical method exists for automatically licensing usage of a service on the Internet. A “dongle” is a hardware device that is attached to an I/O port of the user's computer and used to limit usage by the user to a particular service. A software application confirms the presence of the device prior to granting the user access. This hardware device, however, is clumsy to maneuver between terminals.

The provider of a product or service may issue to the customer a free voucher with every purchase or subscription that invites the customer to access a provider's web site and receive a discount on a next purchase, download supporting software updates and drivers for free, and/or obtain product information. Heretofore, the URL address at which such information could be obtained was printed on the product packaging, CD-ROM, or registration form. To access the appropriate URL address the user had to access an Internet browser, enter the appropriate URL address, and register the purchased product. As discussed in detail above, this process may be cumbersome, especially for individual's inexperienced in the Internet.

Manufacturers and service providers often solicit information from a user visiting a particular URL address. Such information may be used, for example, to ship a product being purchased or to track user profiles for marketing purposes. User's typically are prohibited from proceeding to subsequent pages until they provide the requested information, typically by completing a registration form. Regardless of how well the form is designed, the user generally is discouraged and terminates the impulse to perform the desired action. Even in those instances in which the user completes the form, the information provided therein is often less than accurate thereby distorting the records in the service provider's database. For example, there may be multiple entries for the name “Mr. Donald Duck”.

If the user visits the same web site then the user may be identified using cookies or some other method without having to retype identifying information that has been previously provided. Cookies, however, can only be relied on when the user is operating on a single computer terminal. Furthermore, the user may set their browser so as not to accept cookies or to delete the cookies from the local memory device. An alternative approach commonly used is to register the user based on a user identification and a password. This too raises problems since most web sites do not accept a user's favorite username and password so that they are forced to remember different user identifications and passwords for different web sites. Furthermore, privacy issues once again arise in that the user may not want to be identified. Therefore, it is desirable to develop a unique means for identifying the user without using cookies or user-name entries.

Yet another issue of concern when transacting business over the Internet is the absence of any link between the provider of a service or product and a potential customer. Market surveillance for monitoring whether a user accessing a web site actually purchases the product or service and establishing a relationship to the customer is more difficult on the web. It would therefore be desirable to have a method of verifying the user's identity and automatically directing the verified user to a “member's area” or a personalized homepage, wherein a dialog between the user and potential service/product provider's may be established.

It is desirable to develop a navigation device for a software application environment that solves some of the aforementioned problems.

### SUMMARY OF THE INVENTION

One aspect of the present invention relates to an inexpensive and relatively small sized navigation device that is accessible and mobile so that it may remain in the user's possession at all times, while maintaining the holder's privacy.

Yet another aspect of the present invention is a navigation device that simplifies billing and licensing of a service.

Still another aspect of the present invention is a navigation device that is used to link the provider and purchaser by providing information such as product/service support, free downloads of updated software or drivers, and information on other products.

One other aspect of the invention is to provide a reprogrammable navigation device that is less susceptible to counterfeiting and has an active identity including a processor to support remote authentication.

Another aspect of the invention is to provide a navigation device that automatically transmits to the provider information about the user without such information having to be entered by the user.

In a preferred embodiment the device in accordance with the present invention is used to automatically navigate to a pre-programmed address in a network. The navigation device includes an interface coupling circuit, a microprocessor, a memory device and an input device. The navigation device may be easily transported by the holder and is preferably in the shape of a card or token. The navigation device is programmed to store a unique identification number and at least one network address. In operation, the holder places the navigation device in contact with or in proximity to an interface, whereby the stored network address is automatically retrieved from the memory device and a web browser application is accessed and navigates to the particular address. If more than one address is stored in the memory device, then the navigation device selects the appropriate address based on a condition or event. In addition to automatically navigating the holder to a desired address in the network, the device can be used to automatically navigate to favorite addresses, each being assigned to a corresponding key or sequence of keys on the input device. Accordingly, the holder may access a favorite address in the network, without each time having to enter the appropriate text, by selecting the associated key or sequence of keys via the input device.

The invention is also directed to a navigation device for automatically navigating to at least one application in a software environment. The navigation device includes a memory device for storing at least one preprogrammed identifier. Each identifier is uniquely associated with an application. In addition, the navigation device also includes interface coupling circuitry adapted to transmit information and a processor for automatically accessing the application associated with a selected preprogrammed identifier from the identifiers stored in said memory device. The identifiers stored in the memory device are universally selectable via more than one terminal.

The invention also relates to a system for automatically navigating to at least one application in a software environment. The system including the navigation device as described above, a terminal and an interface for providing communication between the navigation device and the terminal.

In addition, the invention also is directed to a method for using a navigation device as described above to automatically navigate to at least one application in a software environment. The navigation device is first positioned proximate an interface. Thereafter, a selected identifier is retrieved from at least one preprogrammed identifier stored in a memory device of the navigation device. An application associated with the selected preprogrammed identifier from the identifiers stored in said memory device is thereafter automatically accessed.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

The foregoing and other features of the present invention will be more readily apparent from the following detailed description and drawings of illustrative embodiments of the invention wherein like reference numbers refer to similar elements throughout the several views and in which:

FIG. 1 diagrammatically depicts an exemplary system for on-line use of the navigation device in accordance with the present invention, wherein the navigation device is positioned in the interface;

FIG. 2 shows a partial front view of an embodiment of the interface in FIG. 1 that is protected behind a transparent surface to protect against vandalism;

FIG. 3a is a functional diagram of an exemplary interface;

FIG. 3b is a functional diagram of an exemplary navigation device in accordance with the present invention;

FIG. 4 is a front view of the navigation device in FIG. 1 with a portion of the top layer revealed;

FIG. 5 shows a first layer printed onto a bottom lamina of the navigation device in accordance with the present invention;

FIG. 6 shows a second layer printed onto the first layer of the bottom lamina in FIG. 5; and

FIG. 7 shows a third layer printed onto the second layer of the bottom lamina in FIG. 6.

### DETAILED DESCRIPTION OF THE PREFERRED EMBODIMENTS

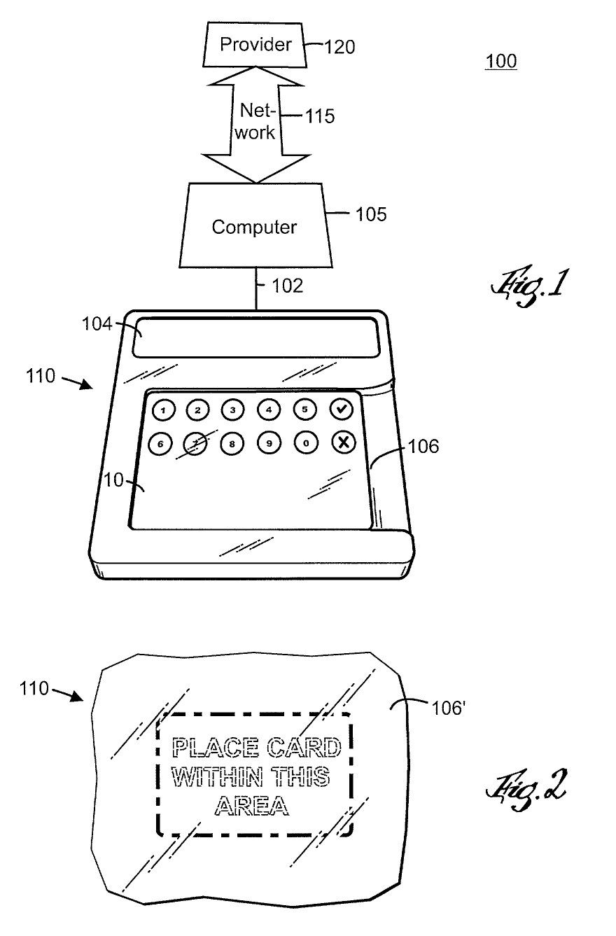

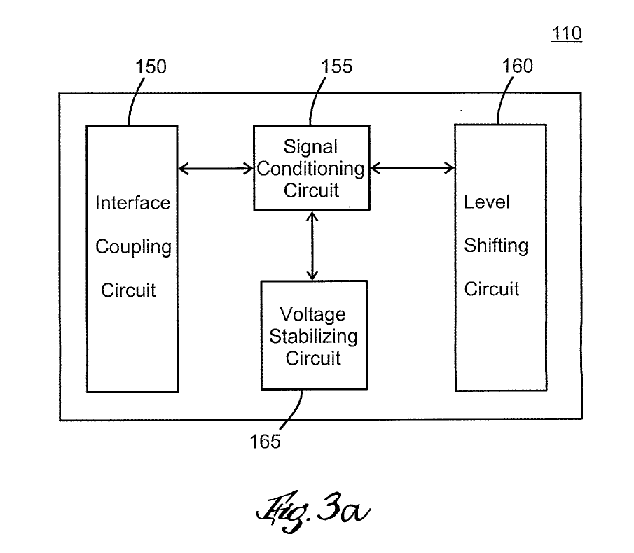

An exemplary system 100 for using a mobile and inexpensive electronic navigational device (hereinafter “navigational device”) in accordance with the present invention is shown in FIG. 1. A computer 105 is connected to an interface 110 via an electrical connection 102. Computer 105, in turn, communicates with a provider 120 via a network 115, such as the Internet, the world wide web, an Intranet, a local area network (LAN), a wide area network (WAN), or a wireless network. Interface 110 is preferably a bi-directional capacitive transceiver, as described in U.S. patent application Ser. No. 09/507,089, filed on Feb. 18, 2000, herein incorporated by reference. Alternatively, interface 110 may be an RF smart-card reader. Navigation device 10 is either placed in proximity to or in contact with the interface 110. By way of example, navigation device 10 is a close-proximity card reader disposed in a receiving region 106 of the interface 110. Although interface 110 is shown as a stand alone device it can also be an integral part of the computer 105. FIG. 2 shows the receiving region 106' after the navigation device 10 has been removed from the interface 110.

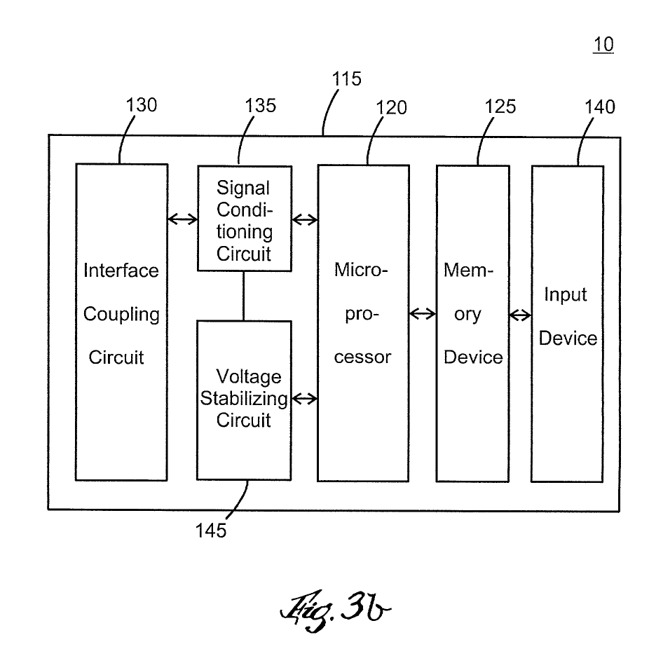

FIG. 3a is a functional diagram of an exemplary interface 110 in accordance with the present invention. In the exemplary embodiment shown in FIG. 3a, interface 110 includes an interface coupling circuit 150, a signal conditioning circuit 155, a level shifting circuit 160 and a voltage stabilizing circuit 165.

FIG. 3b is a functional diagram of an exemplary navigation device 10 in accordance with the present invention. Navigation device 10 preferably includes interface coupling circuitry 130 for coupling to the interface 110, a signal conditioning circuit 135, a microprocessor 300, a memory device 125 (preferably a non-volatile memory device), an input device 320 and voltage stabilizing circuitry 145. Memory device 125 may comprise multiple memory devices or a single device divided into multiple logic sections. A first section of the memory device is programmable and accessible only by the holder and may be used to store such information as addresses, telephone numbers, and nicknames. The issuer of the navigation device 10 is unable to access this information without first receiving the holder's authorization. A holder may program the navigation device to require the issuer to receive the holder's permission prior to releasing any information from the first memory section. Alternatively, the holder may program the navigation device so that the issuer is free to retrieve information from the first memory section without gaining the holder's permission. Thus, depending on the holder's settings, any attempt by the issuer to retrieve information from the first memory section may first require the authorization of the holder either by pressing an “ACCEPTANCE” button, entering a personal identification number (PIN) code on the keyboard, or some other means for acknowledging authorization. Accordingly, the holder maintains complete control over access to the information stored on the navigation device.

A second memory section is programmable and accessible only by the issuer to store a fixed unique identification number or information concerning the user, for example, the user's name, nationality, and point of purchase. Information stored in the second memory section may be altered by the issuer using host application software from a remote location but is not accessible by the holder. Since the information stored in the second memory section may be reprogrammed, the navigation device may be issued to another holder after being reprogrammed. Still a third memory section may be provided as a general purpose storage of information.

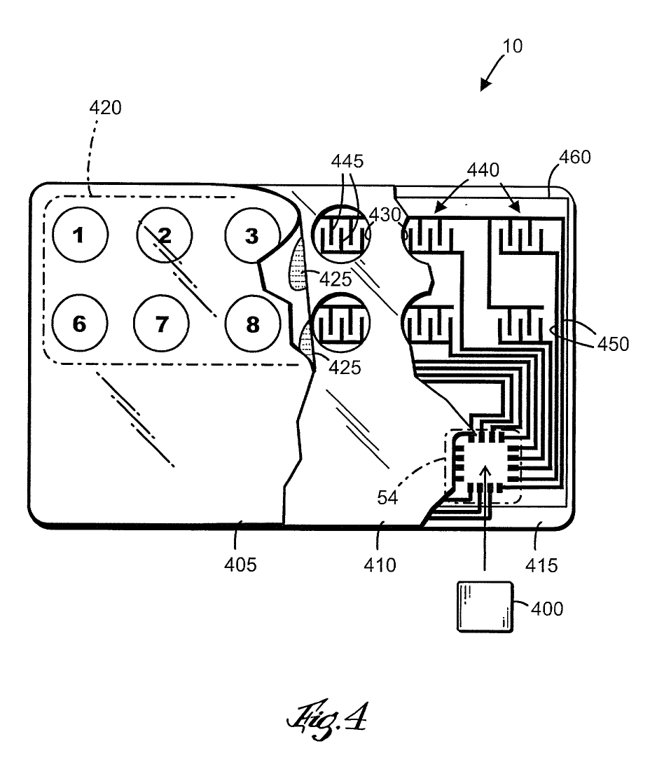

Navigation device 10 in FIG. 1 may be configured in the form or shape of a card having an integrated circuit. In such case, the navigation device is similar to that of a smart card, credit card or debit card and is preferably made from plastic (polymer) or some other type of durable and inexpensive material. As shown in FIG. 4, navigation device 10 is preferably composed of three laminated sheets 405, 410, 415. Each sheet is preferably made of plastic and preferably has a combined total thickness of approximately 0.8 mm (the approximate thickness of a conventional credit card). If the ISO7811/7816 standard for transaction cards is followed, the navigation device may include a magnetic strip to for common usage in existing environments.

In FIG. 4 input device 420 is a twelve key keypad for manual entry of numbers 0-9 as well as “Enter” and “Clear” command keys. Alternatively, input device 420 may be any device by which the user may enter information, for example, using a touch screen display, a voice-activated input device, a keyboard or an individual key. The keys may be any alphanumeric text or symbol. Keypad 420 in FIG. 4 is preferably a membrane-type keypad, similar to that of a credit-card calculator, with embedded keys to protect the electrical contacts from the environment. More precisely, the thin resilient polyester plastic material of the top sheet 405, having printed key symbols on its front face, constitutes the keypad key membrane. Electrically conductive switch pads 425 are printed on the back face of the top sheet 405. Intermediate sheet 410 serves as a spacing layer having circular recesses 430 defined therein and aligned with the switch pads 425. Bottom sheet 415 has an uppermost printed circuit layer 500, as shown in FIG. 5, including switch areas 440 (FIG. 4) aligned with switch pads 425 and circular recesses 430. The arrangement is such that when a user presses a key on the keypad 420, the corresponding conductive switch pad 425 overbridges the space formed by the corresponding recess 430 and contacts an associated switch area 440. A corresponding electric circuit 450, interrupted by a dense pattern of conductors 445 crowding together proximate the switch area 440 is thereby closed. Each electric circuit 450 is connected to the microprocessor integrated circuit 400 via printed connector patches of a connecting interface 455.

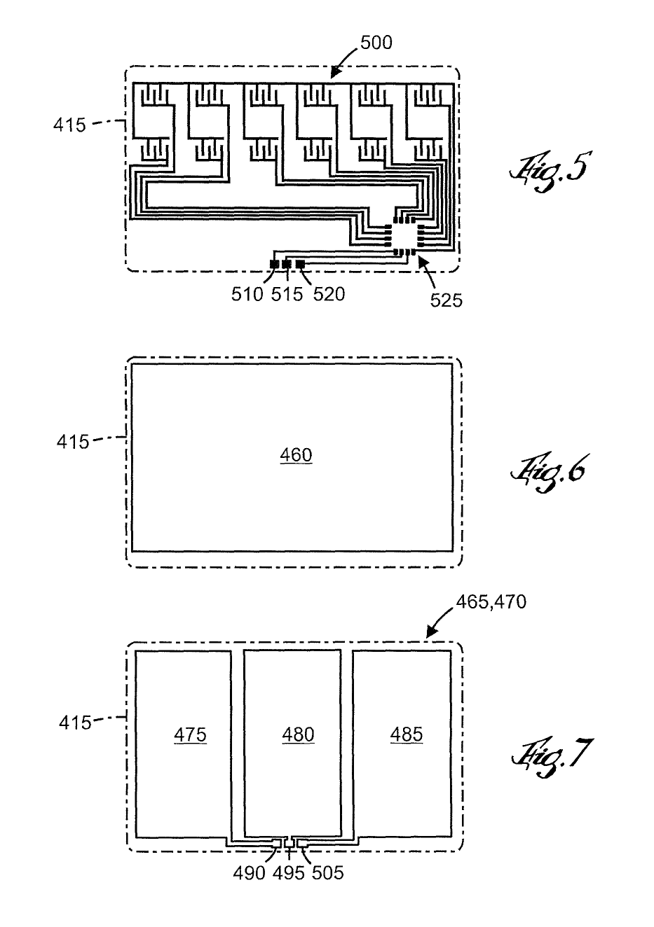

Referring to FIG. 5, the uppermost printed circuit layer 500 forms a top layer in the bottom sheet 415. As shown in FIGS. 6 and 7, bottom sheet 415 includes two underlying additional printed layers, a printed electrically insulating intermediate layer 460 and a printed capacitive bottom layer 465. Bottom layer 465 includes three capacitive patches 475, 480, 485 which are electrically connected to the microprocessor (interface logic) 400 via printed connector patches 490, 495, 505, respectively. When the navigation device 10 is placed in proximity to the interface 110, capacitive patches 475, 480, 485 of the navigation device 10 register with corresponding patches on the interface to form capacitive circuitry for transmitting and receiving information. Printed connector patches 490, 495, 505, in turn, are connected to connector patches 510, 515, 520, respectively, of the connecting interface 525 (FIG. 5) when the top circuit layer is printed onto the insulating intermediate layer 460.

A stroke or sequence of strokes of the input device 420 may be programmed to access different URL addresses stored in the memory. URL programming is preferably accomplished using a separate application associated with the host computer. Prior to entering an access attribute associated with a memory location, the user may be required to enter an access code to prevent unauthorized users from altering the memory settings. Accordingly, the user may use the input device to access their favorite URL addresses from different computer terminals by selecting the appropriate key or sequence of keys, thereby providing a solution to the aforementioned mobility issues associated with conventional favorite folders that were not accessible from different computers.

The navigation device may also be programmed by the issuer or provider to store one or more URL addresses relating to a product or service. In one embodiment, the navigation device is pre-programmed to store a single URL address that is automatically retrieved by the software driver and passed to the browser application. Alternatively, one from among a plurality of pre-programmed URLs may be automatically selected and launched by the browser depending on some condition, such as a physical state of the product and/or its associated packaging, to achieve a different navigation scheme directing the customer to an appropriate web page. The condition may include, for example, whether a product was purchased in a store, whether the packaging has been opened, whether the packaging has been tampered with or damaged during transport. Information concerning the physical state of the product or packaging may be valuable to the provider and used to adapt the support environment to more effectively address the consumer's needs.

An electronic sensor or other conventional detection device may be used to detect the current physical state of the packaging. For example, an electronic sensor may be used to detect whether the packaging has been opened. The interface automatically selects and navigates to an appropriate URL address based on the current physical state of the packaging. This may be particular applicable to monitor the dosage of medication dispensed or whether a package of medication has been opened or tampered.

By way of several examples, the navigation device may comprise part of an intelligent medication box. If the box is detected as being “unopened” by the consumer then the device navigates to a first URL that provides pertinent information prior to usage. In the case in which the box has been “opened” and only a few doses have been ingested, then the device navigates to a second URL that contains information during medication, e.g., to take the medication before each meal. A third URL address may be automatically selected by the processor when only a few doses remain in the package to provide renewal information or next visit to their physician. In response to all of the medication having been dispensed, then the processor may automatically retrieve a fourth URL address that reminds the patient to schedule a follow-up visit with their physician.

Another situation involves a computer hardware product, wherein if the box is detected as being “unopened” then the device automatically navigates to an installation site, while the box, if opened, would navigate to a troubleshooting or registration site.

Instead of storing multiple URL addresses and automatically navigating to the appropriate address based on some event, after the occurrence of a particular event or condition, the issuer or other service provider may reprogram the token device using the server application from a remote location in order to access a different URL address. By way of example, the issuer or other service provider may enter a new URL address to invoke a subsequent navigation after the holder has successfully downloaded some information or an identification/registration form has been completed.

The description thus far has been restricted to the navigation device being designed as a separate device, e.g., a card or a token. Alternatively, the navigation device may be associated with the product itself or the packaging thereof. In one embodiment the token device may be integral with the product or packaging, e.g., form a portion of a sheet of plastic, paper, or cardboard that forms the packaging for the product. While in a second embodiment the navigation device may form a component of the product or packaging, for example, a snap-off component, a removable adhesive sticker or a coupon to be torn off along a perforation or cut out from the packaging. If the product is not too large and/or heavy the navigation device may be integral with the product itself. Even if the product is relatively large and/or heavy the navigation device may form a detachable or removable component thereof, especially if the product itself is not packaged. When practical, or when the product is too large and/or heavy, the stationary mobile relationship may be swapped, that is, the large box and navigation device may remain stationary in the warehouse while a portable interface is placed in contact with or proximity to the navigation device on the box.

In operation, the holder positions the navigation device in contact with or in proximity of the interface which automatically navigates to a pre-programmed URL address for the purchased product where information such as product registration, support information and/or promotion of additional products or services are provided. If more than one URL address is stored in the navigation device, the appropriate address is selected based on an event or condition. An installed software driver or browser plug-in retrieves and navigates to the appropriate pre-programmed URL address. If the Internet browser is not active then the software driver first launches the appropriate browser application before navigating to the pre-programmed URL address.

Navigation to the appropriate URL address may be realized in several ways. In one embodiment, the server application, client application or browser may receive the identification from the navigation device and/or the state of the product or packaging to determine which URL address to launch. Alternatively, the list of pre-programmed URLs may be stored in the token and depending on the state of the product or packaging the driver receives the appropriate URL address to the browser.

An ongoing customer-vendor relationship may be established to provide support and after-sales activities. This is particularly appealing in the Internet environment in which relatively little customer loyalty exists to any particular site or vendor. The relationship may be fostered by creating a link whereby the customer is provided with a relatively easy means for contacting the vendor. In particular, the identity of the customer is verified. Thereafter, the navigation device is used to automatically guide the holder to a personal web-site accessible only by that particular customer where manual or automated feedback about usage of a product or service can be exchanged. Additional information may be conveyed via the personal web-site, such as advertising promotions, discounts and new products or services being offered.

Some exemplary applications are described in which the navigation device in accordance with the present invention is integrated in or forms a component of the packaging of the product. A music CD may be sold with a navigation device pre-programmed so that the web browser software automatically navigates to the artist's web page where discounts are provided and the user may download music samples. In another application, a navigation device provided with a software application may be used to guide the user to the provider's web page that posts information concerning upcoming events, software updates, and discounts. A navigation device may also be used to automatically guide the customer to the appropriate driver for a purchased product at the hardware vendor's site. In a far different context, the navigation device may be used with a medication dispensing scheme. Specifically, the navigation device can be used to monitor demand for the medication and automatically trigger delivery of additional medication to the user based on usage. A counseling program may automatically be invoked based on the usage of the medication, if necessary. By way of example, the medication may be a nicotine chewing gum.

By way of example, the present invention has been shown and described for on-line navigation with a service provider to one or more identifiers, e.g., predetermined URLs, by launching an Internet browser (FIG. 1). It is contemplated and within the intended scope of the present invention to specify other types of identifiers that uniquely identify different resources, such as, file system drivers identified using the standard universal naming convention (UNC), objects identified using a domain name service (DNS) or a Lightweight Directory Access Protocol (LDAP)), document identifiers, or personal folder names. Accordingly, the consumer's software environment may be configured, as desired, by the seller or salesman.

In an alternative embodiment the present invention is equally suitable in an off-line, LAN or local environment wherein the user's settings reside in the device itself. The navigation device may select from one or more document identifiers, folders, or projects, for example, when operating an office program suite of CAD/CAM engineering suite to launch a particular application, e.g., a word processing application. Instead of one or more URLs, the navigation device stores folder names, directory service entries, and/or specific file names. When working in an office it is not uncommon for an employee to move between computer terminals. The navigation device allows an employee to access personal shortcuts and a most recently used list of files irrespective of the terminal from which they are working.

Thus, while there have been shown, described, and pointed out fundamental novel features of the invention as applied to a preferred embodiment thereof, it will be understood that various omissions, substitutions, and changes in the form and details of the devices illustrated, and in their operation, may be made by those skilled in the art without departing from the spirit and scope of the invention. For example, it is expressly intended that all combinations of those elements and/or steps which perform substantially the same function, in substantially the same way, to achieve the same results are within the scope of the invention. Substitutions of elements from one described embodiment to another are also fully intended and contemplated. It is also to be understood that the drawings are not necessarily drawn to scale, but that they are merely conceptual in nature. It is the intention, therefore, to be limited only as indicated by the scope of the claims appended hereto.

What is claimed is:

1. A navigation device for automatically navigating to at least one application in a software environment, comprising:
a memory device for storing at least one preprogrammed identifier, each identifier being uniquely associated with an application;
interface coupling circuitry adapted to transmit information; and
a processor for automatically accessing the application associated with a selected preprogrammed identifier from the identifiers stored in said memory device, said identifiers being universally selectable via more than one terminal.

2. The navigation device in accordance with claim 1, wherein the software environment is a network.

3. The navigation device in accordance with claim 2, wherein the network is one of the Internet, the world wide web, an Intranet, a local area network, a wide area network, and a wireless network.

4. The navigation device in accordance with claim 2, wherein the application is one of an Internet browser, file system driver, object, document, personal folder, and personal file.

5. The navigation device in accordance with claim 4, wherein the application is a an Internet browser and the identifier is a universal resource locator.

6. The navigation device in accordance with claim 1, wherein a plurality of preprogrammed identifiers are stored in said memory device, one of the stored preprogrammed identifiers being automatically selected by said processor based on a condition of one of a product and the product's packaging.

7. The navigation device in accordance with claim 6, wherein the condition is one of a physical state of a product and the product's packaging.

8. The navigation device in accordance with claim 7, wherein the physical state of the product is one of opened and closed.

9. The navigation device in accordance with claim 7, wherein the physical state of the product is one of “tampered”, “physically damaged”, “tilted”, and “storage temperature exceeding acceptable range”.

10. The navigation device in accordance with claim 7, wherein the physical state of the product is one of “present”0 and “removed”.

11. The navigation device in accordance with claim 10, further comprising a detector for detecting the condition.

12. The navigation device in accordance with claim 10, wherein said detector detects a change in conductivity between electrical conductors.

13. The navigation device in accordance with claim 1, further comprising an input device for receiving a user's input of an associated preprogrammed identifier, said processor automatically accessing an application and the associated preprogrammed identifier entered by the user.

14. The navigation device in accordance with claim 13, wherein said input device comprises one of a keyboard, a key pad, an individual key, a touch screen display device, and a voice activated input device.

15. The navigation device in accordance with claim 13, wherein the preprogrammed identifiers stored in said memory device correspond to one of favorite Universal Resource Locator addresses, favorite folders, and favorite files.

16. The navigation device in accordance with claim 15, wherein said input device is used to select and retrieve one of the stored favorite Universal Resource Locator addresses, favorite folders, and favorite files, from said memory device.

17. The navigation device in accordance with claim 1, said device being integral with one of a product and the product's packaging.

18. The navigation device in accordance with claim 1, said device forming a component of one of a product and the product's packaging.

19. The navigation device in accordance with claim 1, wherein the navigation device is in the shape of one of a credit card and a token.

20. A system for automatically navigating to at least one application in a software environment, comprising: p1 a terminal; p1 an interface connected to said terminal; and p1 a navigation device as defined in claim 1, said navigation device being in communication with said terminal via said interface.

21. The system in accordance with claim 20, wherein the software environment is a network.

22. The system in accordance with claim 21, wherein the network is one of the Internet, the world wide web, an Intranet, a local area network, a wide area network, and a wireless network.

23. The system in accordance with claim 21, wherein the application is one of an Internet browser, file system driver, object, document, personal folder, and personal file.

24. The system in accordance with claim 21, wherein the application is a an Internet browser and the identifier is a universal resource locator.

25. The system in accordance with claim 21, wherein a plurality of preprogrammed identifiers are stored in said memory device, one of the stored preprogrammed identifiers being automatically selected by said processor based on a condition of one of a product and the product's packaging.

26. The system in accordance with claim 25, wherein the condition is one of a physical state of a product and the product's packaging.

27. The system in accordance with claim 26, wherein the physical state of the product is one of opened and closed.

28. The system in accordance with claim 26, wherein the physical state of the product is one of “tampered”, “physically damaged”, “tilted”, and “storage temperature exceeding acceptable range”.

29. The system in accordance with claim 26, wherein the physical state of the product is one of “present” and “removed”.

30. The system in accordance with claim 25, further comprising a detector for detecting the condition.

31. The system in accordance with claim 25, wherein said detector detects a change in conductivity between electrical conductors.

32. The system in accordance with claim 20, further comprising an input device for receiving a user's input of an associated preprogrammed identifier, said processor automatically accessing an application and the associated preprogrammed identifier entered by the user.

33. The system in accordance with claim 32, wherein said input device comprises one of a keyboard, a key pad, an individual key, a touch screen display device, and a voice activated input device.

34. The system in accordance with claim 32, wherein the preprogrammed identifiers stored in said memory device correspond to one of favorite Universal Resource Locator addresses, favorite folders, and favorite files.

35. The system in accordance with claim 34, wherein said input device is used to select and retrieve one of the stored favorite Universal Resource Locator addresses, favorite folders, and favorite files, from said memory device.

36. The system in accordance with claim 20, said device being integral with one of a product and the product's packaging.

37. The system in accordance with claim 20, said device forming a component of one of a product and the product's packaging.

38. The system in accordance with claim 20, wherein the navigation device is in the shape of one of a credit card and a token.

39. A method for using a navigation device to automatically navigate to at least one application in a software environment, comprising the steps of:
positioning the navigation device proximate an interface;
automatically retrieving a selected identifier from at least one preprogrammed identifier stored in a memory device of the navigation device; and
automatically accessing an application associated with the selected preprogrammed identifier from the identifiers stored in said memory device, said identifiers being universally selectable via more than one terminal.

40. The method in accordance with claim 39, further comprising detecting an occurrence of one of a condition of one of a product and the product's packaging.

41. The method in accordance with claim 39, wherein said accessing step further comprises automatically accessing one of the identifiers from among the preprogrammed identifiers stored in said memory device based on the condition.

42. The method in accordance with claim 39, wherein the stored preprogrammed identifiers represent one of favorite Universal Resource Locator addresses, favorite folders, and favorite files.

43. The method in accordance with claim 42, wherein said navigation device comprises an input device.

44. The method in accordance with claim 43, wherein said retrieving step comprises receiving a user's selected identifier via said input device.
